(19) United States
(12) Patent Application Publication
(10) Pub. No.: US 2006/0055070 A1
(43) Pub. Date: Mar. 16, 2006

(54) Method of preparing molded articles by means of photopolymerization in visible or near-ultraviolet light

(75) Inventors: Caroline Grotzinger, Rumersheim-Le-Haut (FR); Dominique Burget, Sausheim (FR); Jean-Pierre Fouassier, Morshwiller Le Bas (FR); Gilles Richard, Alforville (FR); Odile Primel, Vincennes (FR); Leanirith Yean, Longjumeau (FR)

Correspondence Address: FULBRIGHT & JAWORSKI L.L.P., 600 CONGRESS AVE., SUITE 2400, AUSTIN, TX, 78701, US

(73) Assignee: Essilor International Compagnie Generale d'Optique, Charenton cedex (FR)

(21) Appl. No.: 10/544,321

(22) PCT Filed: Feb. 3, 2004
(86) PCT No.: PCT/FR04/50041

§ 371 Date: Aug. 3, 2005

(30) Foreign Application Priority Data
Feb. 3, 2003 (FR) 0301214

(51) Int. Cl. B29D 11/00; B29C 35/08

(52) U.S. Cl. 264/1.32; 264/496; 264/1.38

(57) ABSTRACT

The method comprises photopolymerizing by means of a light radiation of the visible and/or near UV field of a composition free of mineral particles, comprising at least one photopolymerizable monomer and at least one photoinitiator selected amongst suberone derivatives and mixtures of α-diketone and an organic peroxide. Application to the manufacture of ophthalmic lenses.

The present invention relates to a method for preparing moulded items from photopolymerizable compositions, i.e. polymerizable under the effect of a light irradiation in the visible and/or near UV field.

This invention also relates to photopolymerizable compositions comprising at least one absorbent additive in the UV and, more particularly, in the near UV.

The invention is applicable to the production of items, such as glass lenses, with minimum thicknesses ranging from 1 to 20 mm.

It is well known to polymerize ophthalmic lenses for glass lenses through photopolymerization.

Generally, one uses a composition comprising one or more photopolymerizable monomers or the blend thereof leading to a photopolymerizable composition, and at least one photo-initiator, generally UV activable.

The composition, typically based on (meth)acrylic monomers, is introduced into a mould, then irradiated through a UV radiation, until gelling and curing. Subsequently, after mould release, the ophthalmic glass is recovered.

It is also well known also to incorporate into glass lenses various additives, such as UV absorbers or photochromic pigments.

UV absorbers allow to delay the lens ageing under the effect of sun radiation.

Photochromic pigments are able to change colour under the effect of a UV radiation.

There are several techniques for incorporating additives into an ophthalmic lens.

The additives could be incorporated after lens manufacture, for example, through thermal transfer at the surface thereof.

There is also a technique involving adding additives in the initial polymerizable composition, and then causing its polymerization.

For example, U.S. Pat. No. 5,621,017 describes polymerizable compositions comprising:
(A) at least one radically polymerizable monomer,
(B) from 0.001 to 0.2 part in weight of a photochromic compound selected amongst spiroxazin, chromene compounds or the mixtures thereof, and
(C) from 0.01 to 1 part in weight of a photopolymerization initiator, per 100 parts in weight of (A).

Amongst the numerous cited photopolymerization initiators are mentioned initiators of the α-dicarbonyl type, such as 1,2-diphenylethanedione.

The above patent discloses that it is possible to add thermal polymerization initiators.

Such a technique makes it possible to manufacture the lens and to incorporate additives in a single step, but however involves implementing problems.

Indeed, the UV radiation is absorbed by the photochromic pigment or the UV absorber, resulting in a decreased polymerization rate. It is particularly difficult to polymerize into the bulk of thick items.

It is then required to increase the radiation intensity so as to obtain a deeply polymerized item, within acceptable times, but high intensities damage photochromic compounds.

This is why it has already been suggested in the state of the art to use photoinitiators, the absorption spectrum of which extends in the visible field and to carry out an irradiation only in the visible field.

U.S. Pat. No. 5,910,516, more particularly, describes a method for manufacturing photochromic items consisting in curing a composition comprising a radically polymerizable monomer, a UV polymerization initiator with a main absorption in the UV field and a molar extinction coefficient at 400 nm equal to 150 lit./(mol.cm) or more and a photochromic compound, the irradiation being carried out through a filter adapted to remove the light radiation below 400 nm.

The photoinitiators to be preferably used in the technique from U.S. Pat. No. 5,910,516 are α-aminoalkylphenones, compounds of the acylphosphine oxide type and bisacylphosphine oxide type.

The patent discloses that it is possible to add to the UV polymerization initiators, thermal polymerization initiators, for example, benzoyl peroxide, azo-bis-isobutyronitrile.

On the other hand, it has been proposed to use photopolymerizable compositions for dental use, comprising a combination of α-diketone initiators and an organic peroxide.

Patent EP 059649 discloses a dental composition comprising at least one acrylic or methacrylic acid polymerizable ester, from 40 to 90% in weight of at least one particle filler, and a visible light sensitive catalyst, the catalyst comprising camphorquinone and at least one organic peroxide.

Practically, the compositions as described in the above mentioned Patent contain a very large amount of mineral fillers (83%), such that the monomer bulk to be polymerized in the dental composition is low.

In addition, even if the compositions as described in the Patent polymerize under the effect of a light radiation in the visible field, it is obvious that the polymer properties, particularly the compression resistance, continue to considerably develop in time, for at least 24 hours after photopolymerization, meaning that the reaction is not yet complete.

Patent EP 090493 describes photopolymerizable compositions having an improved curing capacity under the effet of a visible light, and comprising at least one ethylenically unsaturated polymerizable monomer, at least one ketone selected amongst camphorquinone and the substituted derivates thereof and at least one organic peroxide, the composition containing up to 10% in weight of a filler based on the total weight of the composition.

The examples from the above-mentioned Patent describe the polymerization of very thin layers, being 10 to 50 micrometer thick, between two microscope plates, and show that there is a strong inhibition of the polymerization, although the layer is very thin.

One aim of this invention is to provide a new method for manufacturing a thick and transparent moulded item, particularly useful in ophthalmic optics, through polymerization of a photopolymerizable composition under the effect of a light irradiation in the visible and/or near UV field.

Another aim of the invention is to provide a method for polymerizing a thick and transparent moulded item, containing a UV absorbent additive and preferably a near UV absorbent additive.

In the present application, the following definitions are applied.

A light irradiation in the visible field means an irradiation through a beam made up of electromagnetic waves with wavelengths in the range from 400 to 800 nm.

A light irradiation in the UV field means an irradiation through a radiation made up of electromagnetic waves in the range from 250 to less than 400 nm.

An irradiation in the near UV field means an irradiation through a radiation made up of electromagnetic waves in the range from 380 to less than 400 nm.

Similarly, when an additive or an initiator is mentioned with its absorption spectrum located in the visible, UV or near UV field, this respectively refers to the same wavelength ranges as those defined hereinabove.

A thick item, as used herein, means an item having a minimum thickness ranging from 1 to 20 mm.

The present technical problem is solved using a photopolymerization initiator derived from suberone, or a combination of an α-diketone photopolymerization initiator, with at least part of its absorption spectrum being beyond 380 nm, and an organic peroxide compound.

Thus, the method for polymerizing a thick, transparent moulded item according to the invention comprises the steps of:
incorporating into a mould a photopolymerizable composition, being free of mineral particles and comprising:
A) a component A comprising at least one photopolymerizable monomer,
B) at least one polymerization initiator selected amongst
a photopolymerization initiator derived from suberone,
a mixture comprising at least one α-diketone photopolymerization initiator, with at least part of its absorption spectrum being beyond 380 nm, and an organic peroxide compound;
polymerizing the photopolymerizable composition through irradiation of the latter by a light radiation in the visible and/or near UV field;
recovering the thick and transparent moulded article.

The component A preferably comprises a radically polymerizable monomer, such as a monomer containing one or more, preferably two ethylenic, vinylic, methacrylic or acrylic groups.

Preferred monomers include aromatic di(meth)acrylate monomers, more particularly, a bisphenol-A di(meth)acrylate polyalkylene glycol.

The most preferred monomers have the following formula: 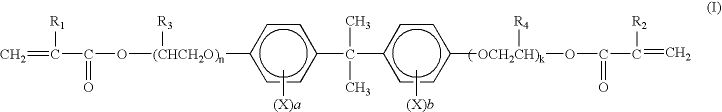
wherein:
R₁, R₂, R₃, R₄ represent, independently from each other, H or CH₃
X represents a halogen atom, such as chlorine or bromine,
n+k ranges from 1 to 20, inclusive the boundary values,
a and b represent independently from one another an integer ranging from 0 to 4, inclusive those boundary values.

Preferably, R₁, R₂ represent CH₃; R₃, R₄ represent H; a=b=0.

The aromatic dimethacrylate monomer is generally the major monomer in the component A and it is used in a proportion from 40 to 90% in weight based on the total weight of component A, preferably from 50 to 90% in weight.

The preferred components A also comprise, in addition to the monomer (I), one or more monomers of the below mentioned formula (II): 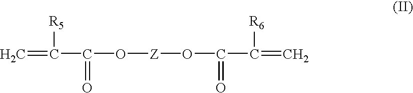
wherein:
R₅ and R₆ represent independently from one another H or CH₃, preferably H;
Z represents a non aromatic group, of the divalent polyalkylene type of a divalent polyalkyleneglycol group.

The preferred Z corresponds to the following formula:
Z=[R₇O]ᵥR₇
wherein R₇ represents a linear or branched alkylene, comprising from 1 to 5 carbon atoms, and v is an integer from 1 to 20.

Preferably, R₇ represents —CH₂CH₂—.

The monomer (II) could be used as the main monomer in component A, but it is generally used as a minor component, in a proportion from 30 to 40% in weight based on the weight of component A.

As previously indicated, the polymerization initiator is selected amongst:
a photopolymerization initiator derived from suberone,
a mixture comprising at least one α-diketone photopolymerization initiator, with at least part of its absorption spectrum being beyond 380 nm, and an organic peroxide compound.

An example of a photopolymerization initiator derived from suberone includes 5H-dibenzo[a,d]cyclohepten-10,11-dione.

The inventors have found that such family of initiators derived from suberone is particularly efficient for carrying out the polymerization of thick items under a visible irradiation and/or near UV irradiation, without requiring to use a co-initiator of the peroxide type.

Such an initiator itself of the α-diketone type, could however also be used in combination with an organic peroxide.

The other photopolymerization initiators of the α-diketone type should be used according to the invention in combination with organic peroxides.

The initiator of the peroxide type allows both to accelerate the reaction kinetics and to act on the optical properties of the resulting final polymer, more particularly, making it colourless or nearly colourless, making therefore optical applications possible.

Preferably, the α-diketone photopolymerization initiator has a maximum molar extinction coefficient of at least 20, preferably at least 30, and more preferably at least 40 lit./mol.cm, in an absorption area higher than 380 nm.

The optimum range of maximum molar extinction coefficient varies from 20 to 140 lit/mol.cm.

Preferably, the absorption spectrum of the α-diketone photopolymerization initiator comprises an absorption peak at 420 nm or more.

More preferably, the absorption of the polymerization initiator increases with the wavelength in an area located in the wavelength range varying from 400 nm to the wavelength at the absorption maximum corresponding to the absorption peak, and subsequently decreases for wavelengths located beyond the wavelength at the absorption maximum.

Preferably, said absorption peak is located between 420 to 500 nm.

The α-diketone photopolymerization initiator is preferably present in a ratio from 0.01 to 1% in weight based on the weight of component A, and more preferably, in a ratio from 0.01 to 0.1% in weight based on the weight of component A.

An α-diketone initiator ratio means the α-diketone and/or suberone derivative ratio, the suberone derivative being itself an α-diketone.

The organic peroxide compound could be of any type of organic peroxide such as benzoyl peroxide and preferably, an hydroperoxide, such as cumene hydroperoxide or tert-butyl hydroperoxide.

The peroxide compound is generally present in a ratio from 0.1 to 0.5% in weight based on the weight of component A.

The organic peroxide/α-diketone weight ratio is preferably higher than 2 and more preferably ranges from 3 to 5, inclusive the boundary values.

The light radiation to which the photopolymerizable composition is subjected is located in a wavelength range belonging to the visible or near UV field.

Obviously, the radiation could further comprise emission bands in the UV lower than 380 nm, which is frequent for existing lamps.

However, it is preferred that the light radiation does not comprise any ray with a wavelength lower than 380 nm, and more preferably, that it does not comprise any ray with a wavelength lower than 410 nm.

In order to achieve this feature, adapted filters are used, being interposed between the lamp and the mould containing the polymerizable composition.

The radiation power emitted on the polymerizable composition as well as the irradiation time are adapted depending on the thickness of the item to be polymerized.

Typically, for a light radiation with a wavelength lower than or equal to 390 nm, the irradiation powers range from 30 to 350 mW(milliwatts)/cm², preferably from 50 to 200 mW/cm² for irradiation periods ranging from 30 seconds to 30 minutes, preferably from 5 minutes to 30 minutes.

Such radiations are measured using a bolometer.

Preferably, the photopolymerizable composition comprises an UV absorbing additive.

Such an additive is indeed different from a polymerization initiator.

Preferably, said additive absorbs in the near UV.

A recommended additive for implementing this invention is a photochromic compound.

The photochromic compound is preferably a spirooxazin or a chromene.

Photochromic compounds of the spirooxazin are described, for example, in U.S. Pat. Nos. 5,139,707, 5,114,621, 5,233,038, 5,529,725, 5,936,016, 6,136,968 and 6,019,914.

Indolinospirooxazins are the preferred spirooxazins.

Photochromic compounds of the chromene type are described, for example, in the following U.S. Pat. Nos. 5,527,911, 5,754,271, 5,631,720, 6,312,811 and 6,281,366.

Naphthopyrans are the preferred chromenes.

Other UV absorbent recommended additives are compounds such as benzotriazoles or benzophenones.

Generally, said UV absorbing additive is present in a concentration ranging from 0.001 to 5% in weight of component A, preferably from 0.01 to 0.2%.

After polymerization and mould release, the moulded item has a minimum thickness ranging from 1 to 20 mm, preferably from 1 to 7 mm.

The moulded item is advantageously a finished or semi-finished ophthalmic lens (i.e. only one of its sides has the required final geometry and the other side is still to be machined (surfaced, then smoothed and/or polished)).

Preferably, the method is applicable to manufacturing glass lenses.

The invention is also relative to a composition which is photopolymerizable under the effect of a light irradiation in the visible or the near UV field, free from mineral fillers, comprising:
A) a component A comprising at least one photopolymerizable monomer,
B) a UV absorbing additive, characterized in that said composition comprises:
B) at least one polymerization initiator selected amongst
a photopolymerization initiator derived from suberone,
a mixture comprising at least one α-diketone photopolymerization initiator, with at least part of its absorption spectrum being beyond 380 nm, and an organic peroxide compound.

The remainder of the specification refers to the accompanying figures, respectively in which:

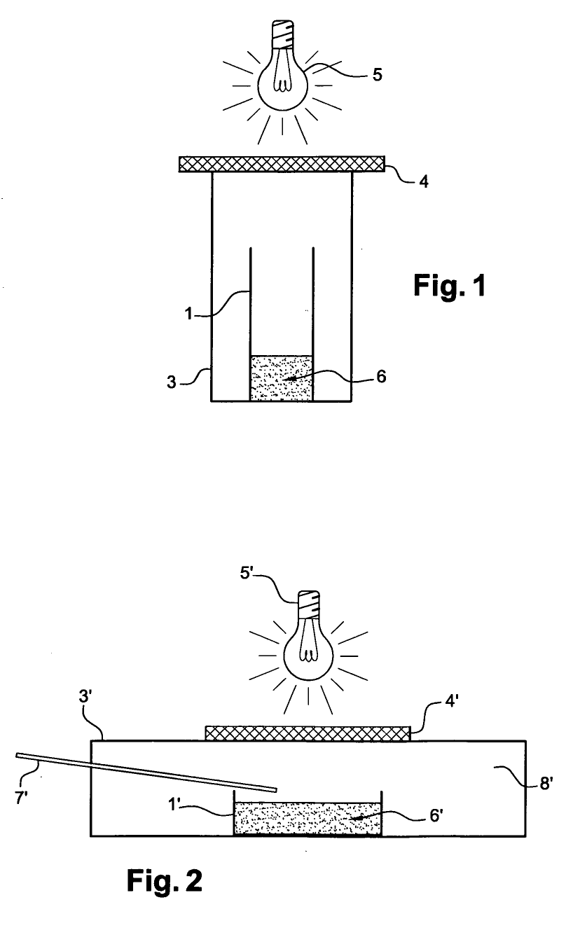

FIG. 1 is a schematic illustration of a device for implementing the method according to the invention; and

FIG. 2 is a schematic illustration of another device for implementing the method according to the invention.

A first type device useful for implementing the method according to the invention is illustrated in FIG. 1 and comprises a cylindrical-shaped mineral glass mould (1), with a 1 cm diameter and a 5 cm height.

The cylindrical mould (1) is arranged in an enclosure (3), being also cylindrical, UV or visible light opaque, in which an opening in the top part thereof is provided on the whole section of the cylinder of the enclosure (3).

At the top of the cylindrical enclosure (3), a glass plate (4) is provided, comprising a high-pass filter, cutting the UV radiation, that recovers the whole opening in the enclosure (3).

A light source (5) having its emission spectrum comprising at least one fraction in the near UV and/or visible field, is provided on top of the glass plate (4), at a defined distance therefrom.

A moulded item is achieved by introducing a polymerizable composition (6) of the previously described type in a sufficient amount to fill the mould (1) up to the desired height, typically 7 mm.

The polymerizable composition (6) in the mould (1) is then degassed through an argon stream (not shown) for a sufficient time, typically 2 minutes, then the mould (1) is closed with a cap, not shown.

The closed mould (1) is then arranged in the cylindrical enclosure (3), the cap is removed, then the glass plate (4) and the high-pass filter are positioned.

Then, the mould (1) is irradiated by means of a lamp (5) through the high-pass filter, so that only the desired fraction of the radiation, in the near UV and/or visible field emitted by the lamp (5) reaches the polymerizable composition (6).

A second type of device useful for implementing the method according to the invention is illustrated in FIG. 2.

It is in overall very similar to the device as shown in FIG. 1. The device in FIG. 2 comprises a cylindrical mould (1′) arranged in an enclosure (3′), being UV radiation or visible light opaque, and also cylindrical. The enclosure (3′) comprises at its top a glass plate (4′), as well as a high-pass filter, not shown.

The mould (1′) has a length lower than the diameter of its cylinder, so that the moulded items will have the shape of a overall planar disc.

The mould (1′) may be made of any material compatible with the polymerizable composition (6′), typically mineral glass or polystyrene.

An inert gas inlet nozzle (7′) emerges into the internal volume (8′) of the cylindrical enclosure (3′).

An inert gas source, not shown, allows to supply the internal volume (8′) of the cylindrical enclosure (3′).

The cylindrical enclosure (3′) is obviously provided with means (not shown) for evacuating the inert gases.

The moulded item is achieved as follows.

The photopolymerizable composition is poured into the mould (1′).

Degassing occurs introducing argon through the nozzle (7′), then the lamp (5′) is switched on and the irradiation starts. Preferably, the argon stream is maintained throughout the whole polymerization duration.

The irradiation is maintained long enough for causing the polymerization of the composition, then, after the irradiation has been stopped, the resulting polymer planar discs are separated from the mould and then released.

The method and the compositions according to this invention have the advantage that they allow, after the polymerization step, to obtain a moulded item having the properties thereof being determined and not (or little) developing in time.

More particularly, it is possible to achieve a polymer of the poly(meth)acrylate type with the conversion rate of the (meth)acrylate functions initially present in the photopolymerizable composition being generally higher than 75%, often higher than 85%, and even higher than 90% after the photopolymerization.

The following examples non limitatively illustrate the present invention.

### EXAMPLE 1

A polymerization device, such as illustrated in FIG. 1 and previously described, is used.

The mould of the device is filled with a polymerizable composition until a 7 mm height of polymerizable composition is achieved in the mould.

The polymerizable composition contains,
as a component A,
i) a component A1 comprising:
80 parts in weight of a monomer of formula (I) (bisphenol A polyethoxydimethacrylate), wherein
n=k=1.25; a=0; R₁=R₂=CH₃; R₃=R₄=H
20 parts in weight of a monomer of formula (II) wherein Z is an ethylenoxy group and v=7 (PEG400 diacrylate); and
ii) 0.05% in weight based on the weight of component A1, of a photoinitiator derived from suberone, referred to as Su: 5H-dibenzo-[a,d]cyclohepten-10,11-dione.

After the composition has been degassed with argon for 2 minutes, the mould is capped.

Before polymerization, the cap is removed, then the polymerization occurs through irradiation for 30 minutes under a 350 W HBO mercury vapour lamp through a filter cutting the UV below 380 nm.

A moulded item is finally obtained, made of a transparent polymeric material and practically colourless through visual inspection.

### EXAMPLE 2

Example 1 is similarly reproduced, with the exception of the polymerization initiator, being a mixture of 0.05 part in weight of Su and 0.2 part in weight of cumene hydroperoxide (HdC) (based on the weight of component A1), instead of Su.

A moulded item is also obtained made of a transparent polymeric material and almost colourless through visual inspection.

### EXAMPLE 3

Example 1 is similarly reproduced, with the exception of the polymerization initiator, being a mixture of 0.05 part in weight of camphorquinone (CQ) and 0.2 part in weight of cumene hydroperoxide (HdC) (based on the weight of component A1), instead of Su.

A moulded item is obtained made in a transparent polymeric material and almost colourless through visual inspection.

### EXAMPLE 4

Example 2 is similarly reproduced, except that component A to be used is CR424 (a composition for an ophthalmic lens based on polyalkyleneglycoldimethacrylate bisphenol A, commercially available from the PPG company), instead of component A1.

A moulded item is obtained made in a transparent polymeric material and almost colourless through visual inspection.

### EXAMPLE 5

Example 1 is similarly reproduced, except that component A to be used is CR424, such as defined in example 4, instead of component A1.

A moulded item is obtained having the same characteristics as the item in example 4.

### COMPARATIVE EXAMPLE 1

Example 5 is similarly reproduced, except that a 2,3-indolinedione photoinitiator is used (Isatin, referred to as Is) instead of Su, and the initiator concentration is 0.1% in weight based on the weight of component A (CR424), instead of 0.05%.

No polymerization could be observed after the 30 minutes of irradiation.

In addition, the monomeric composition has an unwanted yellow colour.

### EXAMPLE 6

Example 5 is similarly reproduced, except that a filter is used cutting the UV below 410 nm.

A cured polymerized final item is obtained.

It can be seen that there is a amount of residual polymer on the surface of the item remained in contact with the air during polymerization. Such an amount could be easily removed through cleaning using an appropriate solvent.

### EXAMPLE 7

Example 3 is similarly reproduced, with the exception that the filter to be used is a filter cutting the UV below 410 nm.

A cured item is obtained with identical characteristics as that in example 6.

### EXAMPLES 8-12 AND COMPARATIVE EXAMPLE 2

In examples from 8 to 12, the photoinitiator/peroxide mass ratio is being varied.

A basic composition is prepared comprising 100 parts in weight of CR424 (bisphenol A polyalkyleneglycoldimethacrylate based polymerizable composition, commercially available from the PPG company), 0.05 part in weight of camphorquinone (CQ).

From this composition, 5 compositions are prepared adding benzoyl peroxide (BeP) and adjusting the amount thereof such that are obtained, for the [BeP]/[CQ] ratios (ratio of weight concentrations), the values as indicated in table I hereinbelow.

Then, each of those compositions is poured in a mould such as illustrated in FIG. 1. After the composition has been argon degassed for 2 minutes, the mould is capped.

The polymerization is carried out, after the cap has been removed, the mould being opened, through irradiation for 30 minutes under a 350 W HBO mercury vapour lamp through a filter cutting the UV below 380 nm.

It is ensured that a true cured polymer is obtained (polymerization: yes) and the colour of the optical article is recorded.

TABLE I

| Exemples | [BeP]/[CQ] ratio | Colour | Polymerization |
|---|---|---|---|
| 8 | 1 | Light beige | Yes |
| 9 | 2 | Light beige | Yes |
| 10 | 4 | Colourless | Yes |
| 11 | 8 | Colourless | Yes |
| 12 | 12 | Colourless | Yes |
| Comparative 2 | 0 | Yellow | Yes |

It can be seen that in the absence of benzoyl peroxide, a polymerization of the polymerizable composition can be observed, but the latter has an unwanted strong yellow colouring.

The presence of benzoyl peroxide allows to decrease or even to remove any colouring.

### EXAMPLES 12-17 AND COMPARATIVE EXAMPLES 3 AND 4

Planar discs are manufactured being 5.5+/−0.5 mm thick from different polymerizable compositions, as listed in table II hereinafter, using the device such as shown in FIG. 2, and following the general protocol for implementing the device in FIG. 2 such as previously described.

A filter cutting the UV below 380 nm is used.

The irradiation by means of a 350 W HBO mercury vapour lamp is maintained for 30 minutes.

Then, the disc final shade is observed, just after mould release, measuring the residual colouring, referred to as RC.
RC=DO₄₂₀−DO₆₈₀
wherein DO₄₂₀ represents the disc optical density at 420 nm
and DO₆₈₀ nm represents the optical density at 680 nm (wavelength at which neither the polymerization initiator nor the monomer absorb).

The discs are maintained for 3 weeks in the air and daylight, then new RC measurements are being carried out.

A RC=RC(3 weeks)−RC (initial) is calculated.

The results are presented in table II.

TABLE II

| | | Comp. B | | RC | RC | |
|---|---|---|---|---|---|---|
| | | initiating | | (Initial, after | 3 weeks after | |
| Ex. | Comp. A | system | % Init* | Polymerization) | polymerization | Δ RC |
| 13 | A1** | Su | 0.05 | 0.08 | 0.11 | 0.03 |
| 14 | CR424 | Su | 0.05 | 0.02 | 0.03 | 0.01 |
| 15 | A1** | CQ/HDC**** | 0.05/0.2 | 0.02 | 0.03 | 0.01 |
| 16 | CR424 | CQ/HDC**** | 0.05/0.2 | 0.02 | 0.04 | 0.02 |
| 17 | CR424 | CQ/BeP*** | 0.05/0.2 | 0.03 | 0.05 | 0.02 |
| Comp. 3 | A1** | CQ | 0.05 | 0.03 | 0.09 | 0.06 |
| Comp. 4 | CR424 | CQ | 0.05 | 0.03 | 0.05 | 0.02 |

* % Init represens the % in weight, respectively indicated for each initiator of the initiating system (component B), based on the weight of component A.
**: this is component A1, such as defined in example 1.
***: BeP: benzoyl peroxide.
****: HDC: cumene hydroperoxide

It can be seen that the discs obtained using the method of the invention have a lower residual RC and/or a higher stability in time, compared to the prior art composition.

### Examples of Polymerization of a Methacrylic Composition Containing a Photochromic Compound

### EXAMPLES 18, 19 AND COMPARATIVE EXAMPLES 5 AND 6

Two polymerizable compositions are prepared through blending of the following components:

Composition 1

100 parts in weight of CR424 (bisphenol A polyalkyleneglycoldimethacrylate based polymerizable composition commercially available from the PPG company),
0.25 part in weight of camphorquinone (CQ),
0.08 part in weight of a Berry Red photochromic compound from James Robinson (Naphthopyran), which is 2,2-di-(4-methoxyphenyl)-5,6-methyl-[2H]naphto[1,2-b]pyran, with the developed formula: 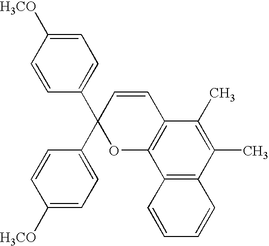
   Composition 2
100 parts in weight of CR424,
0.05 part in weight of camphorquinone,
0.20 part in weight of benzoyl peroxide,
0.08 part in weight of the Berry Red photochromic compound from James Robinson.

Each of the above listed compositions is placed in mineral glass mould for ophthalmic lens, comprising two mineral glass mould parts, maintained spaced apart by a joint, such that the final lenses all have the same thickness of 2 mm.

Both thus filled moulds are irradiated with an Indium and Gallium doped Primarc Hg lamp, having most of its emission spectrum in the visible field.

More precisely, the emission spectrum of such a lamp has a set of emission peaks between 400 and 450 nm, a high emission peak around 550 nm and a double emission peak around 680 nm.

The irradiation times, the radiation power as well as the nature of the filters to be used are listed in table III hereinafter.

After the ophthalmic lenses have been mould released and recovered, the lenses are all subjected to the same UV irradiation for activating the photochromic compound, and visually inspected. The lenses are then classified according to their colour after the photochromic compound has been activated.

“Very active photochromic” means a vivid visually perceived colour, just after the exposure.

“Moderately active photochromic” means a visually perceived clearly less vivid colour.

Little active photochromic means that the colouring is very limited and hardly visible.

The results are also presented in table III.

TABLE III

| | | Irradiation conditions | | |
|---|---|---|---|---|
| | | Irradiation time | | Performances |
| | | without | with a | of the |
| | Com- | a filter | 420 nm filter | photochromic |
| Examples | positions | 30 mW/cm2 | 115 mW/cm² | compound |
| Comparative | Composition | 2,100 | | Little |
| ex. 5 | 1 | seconds | | active |
| | | | | photochromic |
| Comparative | Composition | | 1,000 | Moderately |
| ex. 6 | 1 | | seconds | active |
| | | | | photochromic |
| Exemple 18 | Composition | 2,100 | | Very active |
| | 2 | seconds | | photochromic |
| Exemple 19 | Composition | | 1,000 | Very active |
| | 2 | | seconds | photochromic |

It can be seen that, in the compositions according to the invention, the photochromic effect is maintained, while such an effect is strongly damaged or even nearly inexisting in those compositions only using camphorquinone as the initiator (comparative examples 5 and 6).

1-24. (canceled)

25. A method for polymerizing a thick, transparent molded item, comprising:
incorporating into a mold a photopolymerizable composition that is substantially free of mineral particles, the composition comprising:
(a) a component A comprising at least one photopolymerizable monomer; and
(b) at least one polymerization initiator further defined as
a photopolymerization initiator derived from suberone; or
a mixture comprising at least one α-diketone photopolymerization initiator, with at least part of its absorption spectrum being beyond 380 nm, and an organic peroxide compound;
polymerizing the photopolymerizable composition through irradiation of the latter by a light radiation in the visible and/or near UV field; and
recovering a thick and transparent molded item.

26. The method of claim 25, wherein the photopolymerizable composition comprises a UV absorbing additive.

27. The method of claim 26, wherein the additive absorbs in the near UV.

28. The method of claim 26, wherein the additive is a photochromic compound.

29. The method of claim 26, wherein the photochromic compound is a spirooxazin or a chromene.

30. The method of claim 26, wherein the additive is present in a concentration ranging from 0.001 to 5% in weight of component A.

31. The method of claim 25, wherein component A comprises at least one aromatic di(meth)acrylate monomer.

32. The method of claim 31, wherein the aromatic di(meth)acrylate monomer is a bisphenol A polyalkyleneglycol-di(meth)acrylate.

33. The method of claim 32, wherein component A further comprises a non aromatic poly(alkyleneglycol)di(meth)acrylate monomer.

34. The method of claim 32, wherein component A further comprises at least one poly(alkyleneglycol)diacrylate monomer.

35. The method of claim 25, wherein the α-diketone photopolymerization initiator has a maximum molar extinction coefficient of at least 20 lit./mol.cm in an absorption area higher than 380 nm.

36. The method of claim 25, wherein the absorption spectrum of the α-diketone photopolymerization initiator has an absorption peak at 420 nm or more.

37. The method of claim 35, wherein the absorption peak ranges from 420 to 500 nm.

38. The method according of claim 25, wherein the α-diketone photopholymerization initiator is present in a ratio of 0.01 to 1% in weight based on the weight of component A.

39. The method of claim 38, wherein the α-diketone polymerization initiator is present in a ratio of 0.01 to 1% in weight based on the weight of component A.

40. The method of claim 25, wherein the organic peroxide compound is a hydroperoxide.

41. The method of claim 25, wherein the peroxide compound is present in a ratio of 0.01 to 0.5% in weight based on the weight of component A.

42. The method of claim 25, wherein the organic peroxide/α-diketone weight ratio ranges from 3 to 5.

43. The method of claim 25, wherein the light radiation does not comprise any ray with a wavelength lower than 380 nm.

44. The method of claim 43, wherein the light radiation does not comprise any ray with wavelength lower than 420 nm.

45. The method of claim 25, wherein the molded item has a minimum thickness ranging from 1 to 20 mm.

46. The method of claim 45, wherein the molded item has a minimum thickness ranging from 1 to 7 mm.

47. The method of claim 25, wherein the molded item is a finished or a semi-finished ophthalmic lens.

48. The method of claim 47, wherein the molded item is a glass lens.

49. A composition comprising:
(a) a component A comprising at least one photopolymerizable monomer;
(b) a UV absorbing additive; and
(c) at least one polymerization initiator, further defined as
a photopolymerization initiator derived from suberone; or
a mixture comprising at least one α-diketone photopolymerization initiator, with at least part of its absorption spectrum being beyond 380 nm, and an organic peroxide compound;
wherein the composition is photopolymerizable under the effect of a light irradiation in the visible or near UV field and is substantially free from mineral fillers.
